(19) United States
(12) Patent Application Publication
(10) Pub. No.: US 2014/0036521 A1
(43) Pub. Date: Feb. 6, 2014

(54) ROADWAY AND STREET LIGHTING APPARATUS AND ARRANGEMENT

(71) Applicant: Adam Elliott, Saggart (IE)

(72) Inventor: Adam Elliott, Saggart (IE)

(21) Appl. No.: 14/110,704

(22) PCT Filed: Apr. 10, 2012
(86) PCT No.: PCT/EP12/56474

§ 371 Date: Oct. 22, 2013

(30) Foreign Application Priority Data
Apr. 8, 2011 (IE) S2011/0171

(51) Int. Cl. F21S 9/03; F21S 9/04

(52) U.S. Cl. CPC F21S 9/037; F21S 9/043
USPC 362/459; 362/157; 362/158; 362/192

(57) ABSTRACT

A roadway and street lighting apparatus (200) comprises a sensor (214) to detect movement, and a light source (202) for emitting light, a solar panel (206) for providing energy to the light source, all provided in one apparatus. The apparatus does not rely on mains electricity supply and so the current electricity supply can be left disconnected. The lighting device is 100% renewable, stand alone, self sufficient unit which can be operated without the mains electricity supply. The apparatus is durable, sturdy and easy to maintain.

The present invention relates to an improved roadway and street lighting apparatus and arrangement.

### BACKGROUND TO THE INVENTION

The current state of the art is typified by the following patent publication:

United States Patent Publication No. US 2010/0220467 discloses an apparatus for providing power to an illumination device. The apparatus uses power produced by a wind turbine and a solar array. The wind turbine is disclosed as being a vertically orientated curved turbine and the solar array may be a single or a plurality of solar panels. The illumination device, wind turbine and solar array are disclosed as being suitable as a cost efficient substitute for commercially powered street lights and related devices without any need for trenching power lines or paying commercial power.

A disadvantage of US 2011/0310596 is that this unit cannot be used on roadways as it cannot be used on an over hang light and emits light through 360 degrees instead of directional. The units of KR101061477, US 2011/0170283 and U.S. Pat. No. 7,976,180 cannot be retrofitted to existing units at a reasonable initial cost and or running costs as all prior art units are prone to vandalism. US 2011/0170283 requires a replacement or upgraded existing pole or column.

A disadvantage of the apparatus disclosed in US Patent Publication No. US2010/0220467 is that the apparatus consists of three separate units, namely, the illumination source, the solar panel extending outwardly from a support structure and the wind turbine mounted separately at the top of the supporting pole. Therefore, for this apparatus to be put into use, a street lamp and its existing support pole would have to be removed and replaced in its entirely with the apparatus of this US patent publication. In practice, this has tended not to happen with this type of apparatus due to the expense involved in carrying out such a whole scale replacement of lighting structures along a street or roadway.

As with all previous solar street lighting devices, trenching of some kind has to be dug in order to accommodate and secure a battery pack. If a battery pack is not used then the usual ducting with associated labour for power lines will be required.

Chinese Utility Model Publication No. CN 201145194U relates to a combined device of solar street lighting which has functions of lighting and decoration. The combined device comprises a solar panel, a fully-closed maintenance-free storage battery, an intelligent controller, an integral movable lamp holder component with a quick coupling for LGT-LD solar lamp. The aim is to save energy using solar energy, facilitating change of common street lights into solar street lights.

However, none of the prior art publications discloses a single unit comprising a lighting source supplied with solar power which unit can conveniently replace an existing lighting fixture on a pole or column.

GB 2372382 (A) 2002/08/21 stand alone unit cannot be fitted to existing poles as the unit does not create enough power to run a street light using this solar or wind array. It has not solved the problem of over heating, power production, power usage or storage. A direct from wind turbine can not be used to create the power as the turbine would not fit on the light head.

The present invention seeks to alleviate the disadvantages associated with the prior art.

Accordingly, the present invention provides a roadway and street lighting apparatus comprising a sensor to detect movement, and a light source for emitting light, a solar array and a bull wind turbine for providing energy to the light source and lithium ion batteries or similar for storing said energy, all provided in one unit.

The improved lighting apparatus of the present invention does not rely on mains electricity supply and so the current electricity supply can be left disconnected. Thus, the improved lighting device of the present invention is a 100% renewable, stand alone, self sufficient unit which can be operated without the mains electricity supply and which can be retrofitted to existing poles, is aesthetically pleasing and is not prone to vandalism as existing prior art units with battery storage at the base of the pole.

The present invention also provides a lighting apparatus arrangement comprising at least two solar arrays which are provided abutting each other at a predetermined angle and arranged over a lighting source and adapted such that heat generated by the lighting source is directed towards the solar panels.

The second solar array only becomes visible when the first solar array is turned towards the sun's path and locked in place by the installer. The solar array swivels on top of the light head and can be turned through 360 degrees prior to being locked in place in the optimum orientation in the sun's path.

Ideally, the means for directing the heat generated by the lighting source towards the solar panels includes a tunnel leading from the region of the lighting source to the region of the solar panel.

Preferably, the roadway and street lighting apparatus also includes a wind turbine to provide a back up source of energy supply to the light source. Preferably, in the arrangement of the present invention, the wind turbine is mounted above the solar panel.

The wind turbine is a bull wind turbine which uses an elastic sleeve, a castellated washer and steel pin as a gearbox. As the bull head spins in the wind, the elastic sleeve tightens and is stopped from returning using the castellated washer and pin as one way valve. When fully turned at the end of the threaded/screwed cycle, the turning elastic turbine is what generates the wind power. This provides a vertical aesthetically pleasing to scale turbine which is economically viable while generating power.

Ideally, the light source comprises an array of Light Emitting Diodes (LED's). The light source is contained in a magnification globe on a fused switch with one working and the other spare to act as a backup for reliability and ease of service.

The lighting apparatus of the present invention also comprises means for dispersing heat away from the light source and preferably, directing the heat towards or to the solar panels. The means for dispersing heat comprise a heat dispersing device (HDD) which transfers heat from the region of the light source to a heat sump and then to the outside atmosphere so as to prevent overheating of the lighting apparatus even when the improved lighting device of the present invention is operated in warm or hot climates.

Preferably, the heat dispersing device (HDD) may include charcoal thereby providing a charcoal air conditioning device (CACD). Advantageously, the means for directing heat towards or to the solar panels comprises an air flow tunnel for carrying warm air from the light source and/or heat sump toward or to the solar panel. Directing warm air from the LED array and heat sump to the solar panels using the wind tunnel ensures that the solar panels are kept operational in even extremely cold conditions. Directing the warm air to the solar panels to enable heat transfer at the solar panels is a key feature of the low maintenance lighting apparatus of the present invention. Using this warm air and directing it through the wind tunnel to the solar panels ensures that the solar panels are maintained at above 4° C.

The means for dispersing heat also comprises a venting system including vents in the light source housing which allow cool air to enter and also includes venting apertures in the region of the solar panels through which apertures, warmed air can exit. In cool climates where the temperature drops to minus degrees, the air flow tunnel(s) of the present improved lighting device carry warm air to the solar panels which prevents ice or snow from covering the solar panels and delaying or preventing solar panel energy output.

Preferably, the means for dispersing heat also comprises a wind tunnel through which the warmed air may flow so as to exit through the venting apertures.

The lighting apparatus of the present invention utilises solar energy from photovoltaic cells and a wind turbine which is preferably, a vertically orientated curved bull wind turbine for power generation and supply of power to the lighting source. The bull wind turbine is not prone to damage from vandalism due to its location and size. The bull wind turbine is positioned on a ball and socket returning joint to withstand acts of nature, vandalism and create extra energy output which is available to the LED array or for harnessing to mains electricity supply grid.

The bull turbine has a dispenser spinning just above the solar array which holds de-icer for cold climates or oil based cleaner for hot climates having dust and sand. The winding noise made from the turbine as in generates power under elastic spin is amplified to warn off wildlife.

The improved roadway and street lighting apparatus includes a coupling adapted for connecting the apparatus to an existing support structure such as a support pole. Indeed, the present improved lighting device can be mounted on any support, including a timber frame, for instance, since the present lighting device does not require any electricity feed from the mains electricity grid.

Thus, the improved roadway and street lighting apparatus and arrangement has the advantage that it is not necessary for all the elements of the apparatus to be replaced in their entirety including replacement of the supporting pole or column when replacing existing street/roadway lighting with the improved roadway and street lighting apparatus of the present invention.

It can be retrofitted to existing poles and needs no outside assistance or parts, is aesthetically pleasing and is only as prone to vandalism as existing hardwire units. The only parts on said column or pole is the apparatus itself.

The coupling adapted for connecting the lighting apparatus of the present invention to an existing support structure; and preferably, in one embodiment, the coupling comprises an opposite threaded coupling. However, the coupling may comprise any one of the following: opposite threaded joint, a bore hole with screw locks, a threaded collar or such like coupling which allows the lighting apparatus to be directly mounted to an existing lighting support structure.

The lighting apparatus of the present invention provides “smart” lighting control levels including the solar panel sensing day/night switch and a PIR sensor to ensure that lighting is provided as and when needed for the pedestrian and vehicular traffic, thereby having the significant advantage of ensuring sufficient lighting for the protection of all roadway users. The apparatus can be used with a PIR sensor for detection of movement or smart lighting which uses the input on the solar array as a day and night switch.

In order to provide an improved lighting systems and to enable the easy fitting of the lighting apparatus of the present invention from new ducting without large scale disruption, replacement columns and the added cost, novel mounting brackets are included in the lighting apparatus of the present invention so that the lighting unit of the present invention can be fitted to any column or existing mounting. This allows for an affordable easy to install and easy to replace improved lighting system.

The lighting apparatus of the present invention is different from any existing street light such as those disclosed in CN201145194U, US2011310596, KR101061477 and CN2908996U, US2011170283, U.S. Pat. No. 7,976,180 since all its components, running parts, power supply and storage, LED head, running systems heat sumps and deflectors are inside a sealed system and can be retrofitted to existing including over hanging (rightangle) units.

The lighting apparatus of the present invention requires no outside power source connected with wires running around the light (CN201184572U). The lighting apparatus of the present invention is self sufficient and can be connected to any existing light pole or mounting. This feature again has a huge advantage over the prior art, such as that disclosed in Chinese patent publication no. CN200949769U.

The lighting apparatus of the present invention includes a lighting source comprising an array of Light Emitting Diodes (LED's). This array can comprise two lighting sheets though this may vary, depending on customer choice. Ideally, approximately 50% of the LED's included in the LED array are not essential for initially operating the lighting apparatus and as such, there is approx 50% spare capacity included in the LED array which is installed in the lighting apparatus of the present invention. These spare LED's will turn on when other LED's fail. LEDs last for more than 10 years and so this expected lifespan is doubled with the lighting apparatus of the present invention due to the 50% extra LED capacity included in the LED array.

Advantageously, the lighting apparatus of the present invention has a Heat Deflector Device above the protective glass and magnification globe, LED sheet and below heat sump, layered above heat sump to another HDD shaped around three Lithium ion batteries 50% of which is used capacity, layered above Battery's a HDD with a heat sump one outside casing and solar panels, at a 45 degree angle lining both sides which creates a wind tunnel directed to HDD running the length of the light. Up through the middle, there is a turn table which the solar panel sits on and can be turned to face optimum sun when fitted and locked with pin. On top of turn table, up through a 25 mm hole where solar meet, bull wind turbine sits at highest point. In use, as the wind turbine spins under the action of the wind, the turbine turns a fan at the base above the heat sump.

The lighting apparatus of the present invention has two on-off controls the solar panels are used as a day night switch with a 100 m directional sensor below the light, which in turns triggers the adjacently located lighting apparatus.

The lighting apparatus of the present invention comprises a Heat Dispersal Device which in one embodiment, may comprise a compact sponge stones fed with rain water where applicable and condensation in warm climate with the wind fan feeding the heat sump. The improved lighting device of the present invention uses the same heat dispersing shield (HDD), wind tunnels and Charcoal Air Conditioning device (CACD) in all climates and settings. The CACD is supplied, in hot climates, using condensation and the heat and warm air which is distributed using fans and the wind tunnel which directs the warm air from the lighting source (LED array) to the solar panels where the warm air can be used to heat the solar panels so as to thaw any frost/ice or snow that may have lodged on the solar panels during extreme weather conditions. The warm air is then vented to the atmosphere through the venting apertures in the solar panels. In minus degree temperatures, the heat sump will be cooled by directing warm air through the wind tunnel and released over the face of the solar panels to prevent freezing over of the solar panels.

The lighting apparatus of the present invention control panel is situated in the tip of the light away from the heat source and with no expensive unreliable digital devices (such as disclosed in KR20040010874). In the present invention, any preferred running set up can be matched. Also, double the capacity of batteries can be stored utilising the hollow created by the solar array of the invention.

In the lighting apparatus of the present invention, power may be generated by the solar panels and/or the wind turbine in excess of the power that is needed to operate the LED's. In one preferred embodiment, the lighting apparatus of the present invention includes means for transferring any such excess power generated by the solar panels and/or the wind turbine not needed to operate the LED's to the main electricity grid. Thus, the lighting apparatus of the present invention has electricity grid return capabilities using the pre-existing electricity supply feeds.

Furthermore, the lighting apparatus of the present invention may include a power point for connection to electric vehicles (EVs) such as electric cars whereby the batteries of electric vehicles can be re-charged using the power generated by the solar panels and the wind turbine included in the lighting apparatus of the present invention.

Electric vehicles (EVs) including electric cars can be charged using a fast charge supplied using groups of approximately 100 (approx one hundred) of the lighting apparatuses of the present invention with the electrical power being supplied from the lighting apparatuses to a storage point such as a “holding tank”, using the main grid return supply thereby creating/providing a garage forecourt for electric vehicles (EVs).

In a preferred embodiment, the lighting apparatus of the present invention includes a vandal guard which for instance, can be incorporated into the lighting housing.

Furthermore, in a further alternative embodiment, a camera for monitoring speed of vehicles can be included in the lighting apparatus of the present invention. This can be gauged using the 100 m PIR sensor to determine the time period that elapses between a vehicle passing a first lighting device of the present invention and the next lighting device of the present invention. There is no need for expensive cameras. On country roads, by providing the lighting devices of the present invention, for minimal costs, an early warning system is provided with increased visibility measured in Km instead of the prior situation with visibility of 50-100 m but sometimes as low as 5 m at certain times of the year.

The lighting apparatus of the present invention has the advantage that it is a stand alone, self-sufficient unit having no outside parts power supply or storage (such as is disclosed as being necessary in CN101561096 or KR20010068028). These features make the present lighting apparatus durable, sturdy and easy to maintain, therefore providing significant advantages over the prior art such as disclosed in CN200949769U and JP2002015610.

The present invention will now be more particularly described with reference to the accompanying drawings, in which is shown, by way of example only, two embodiments of the lighting apparatus of the present invention.

In the drawings:

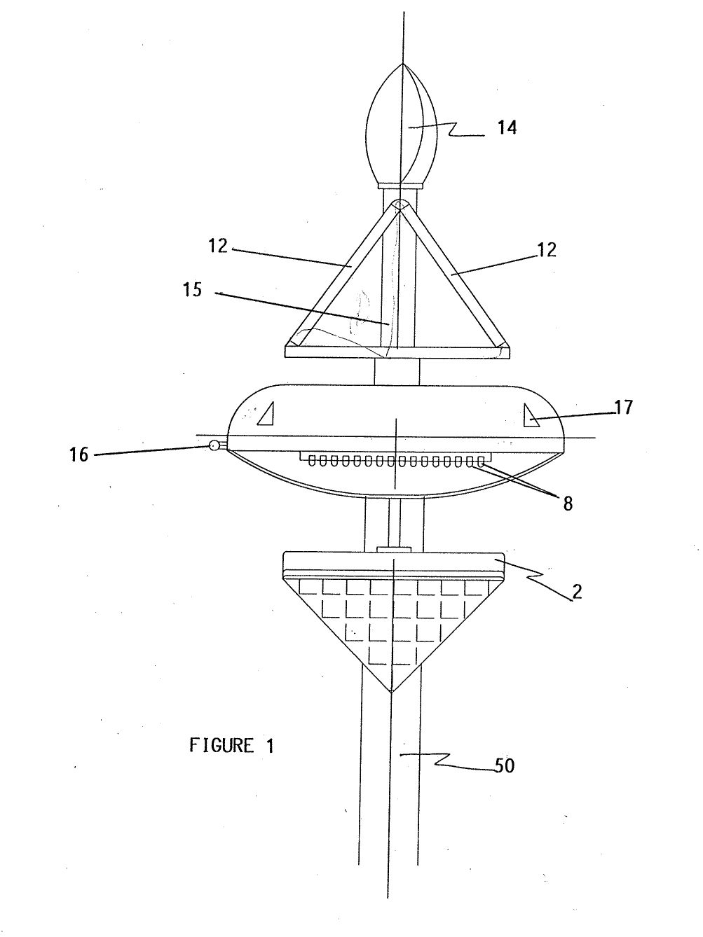

FIG. 1 is a sectional view of the roadway and street lighting apparatus of the first embodiment of the present invention utilising a solar array, returning bull turbine and heat dispersal from the added electronics and set up from lithium gel batteries, quantum solar cells and liquid LED's;

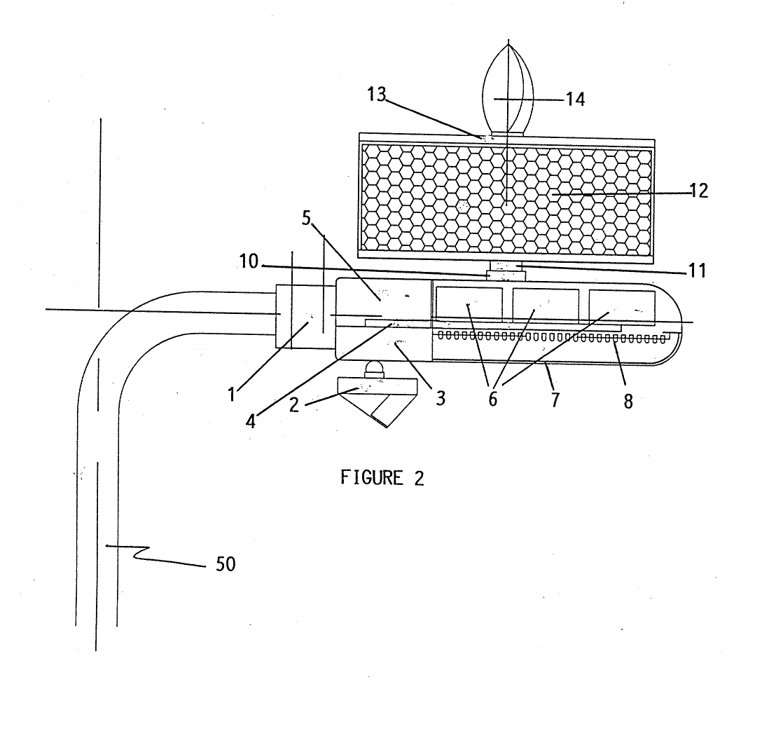

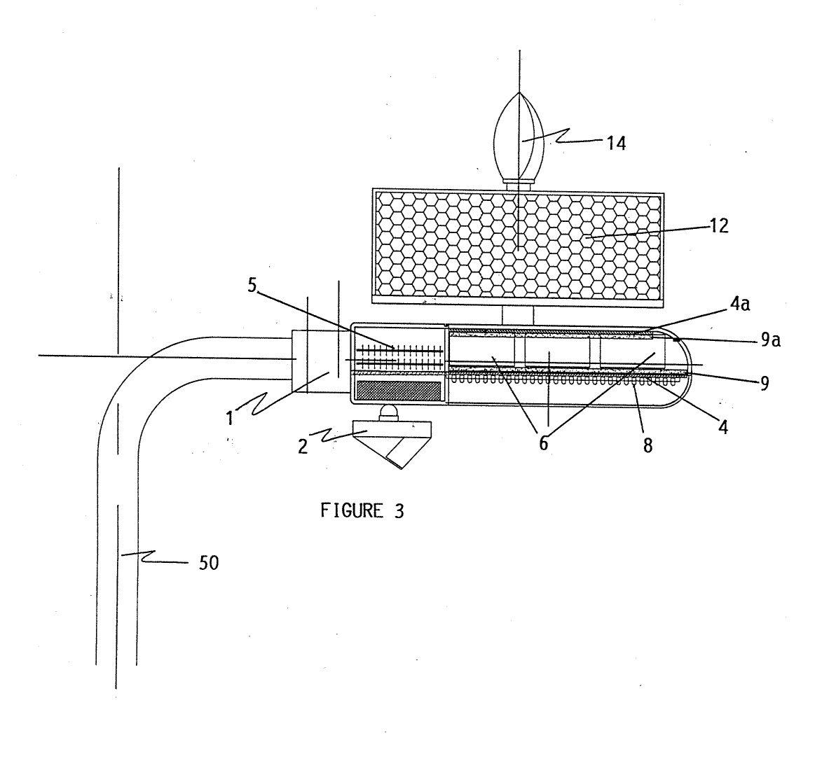

FIG. 2 is a side sectional view of the roadway and street lighting apparatus of the first embodiment of the present invention;

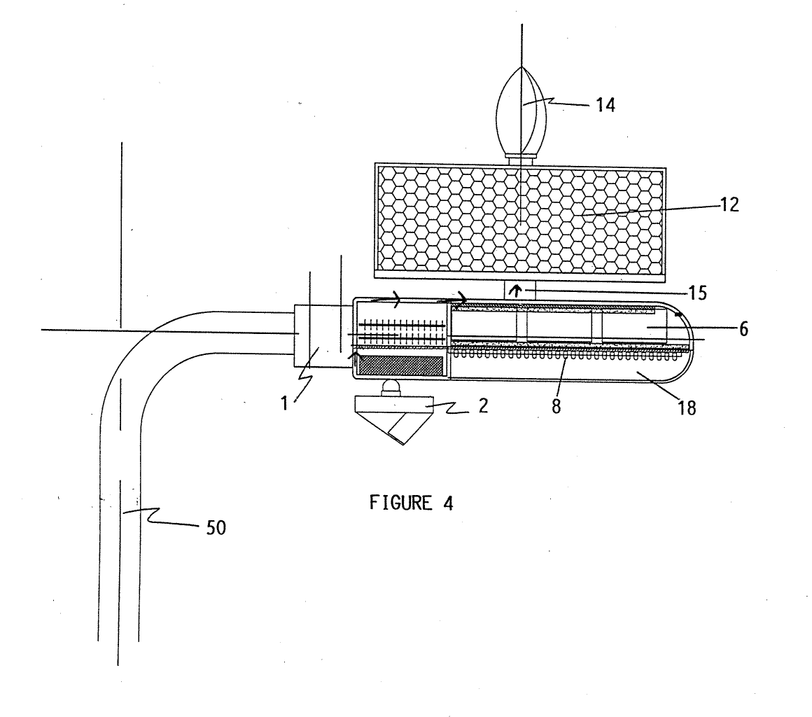

FIG. 3 is a further side sectional view of the roadway and street lighting apparatus of the first embodiment of the present invention;

FIG. 4 is the same side sectional view of the roadway and street lighting apparatus as shown in FIG. 3 but with arrows included to show the direction of air flow to remove heat generated by the LED array and to prevent heat accumulation and build up in the heat sump;

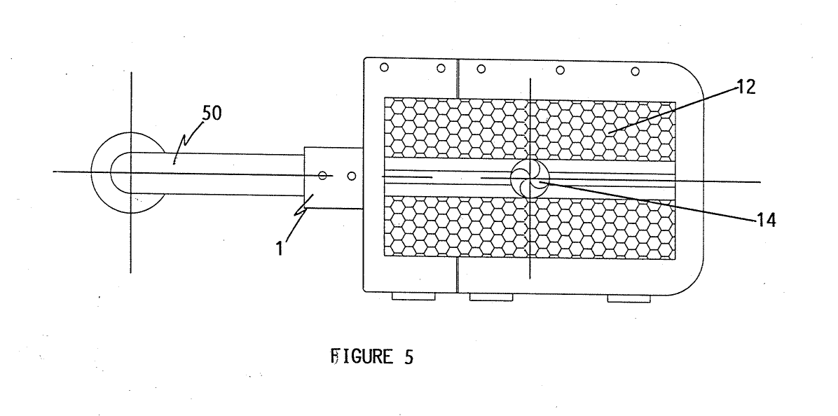

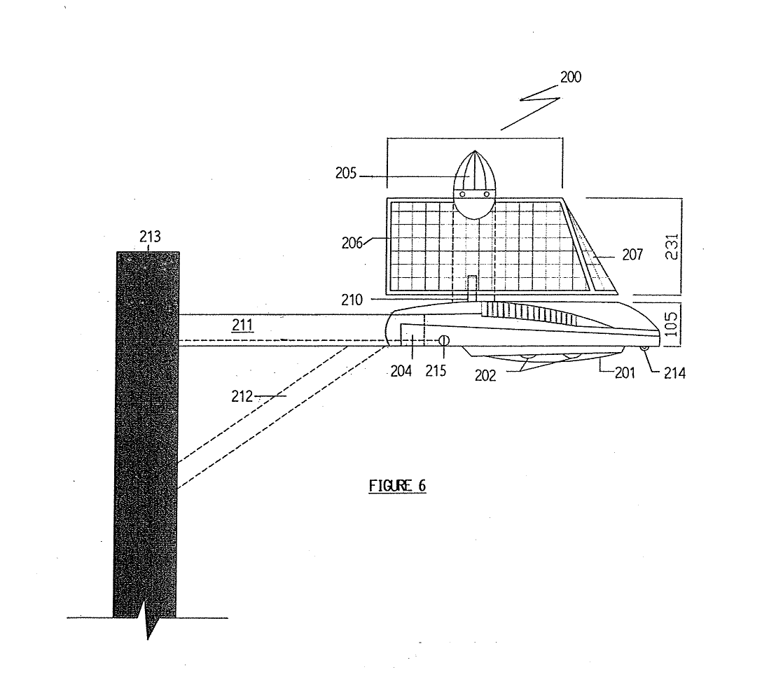

FIG. 5 is a plan view from underneath of the roadway and street lighting apparatus of the first embodiment of the present invention;

FIG. 6 is a side view from one side of the lighting apparatus in a second embodiment of the present invention;

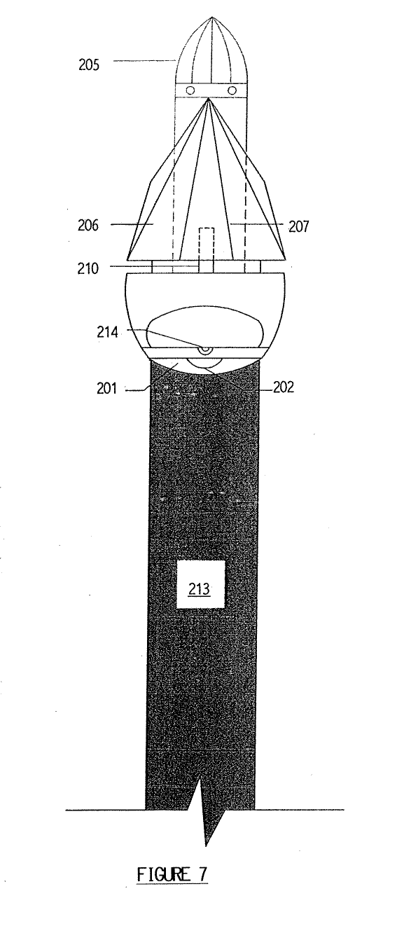

FIG. 7 is a front view of the lighting apparatus in the second embodiment of the present invention;

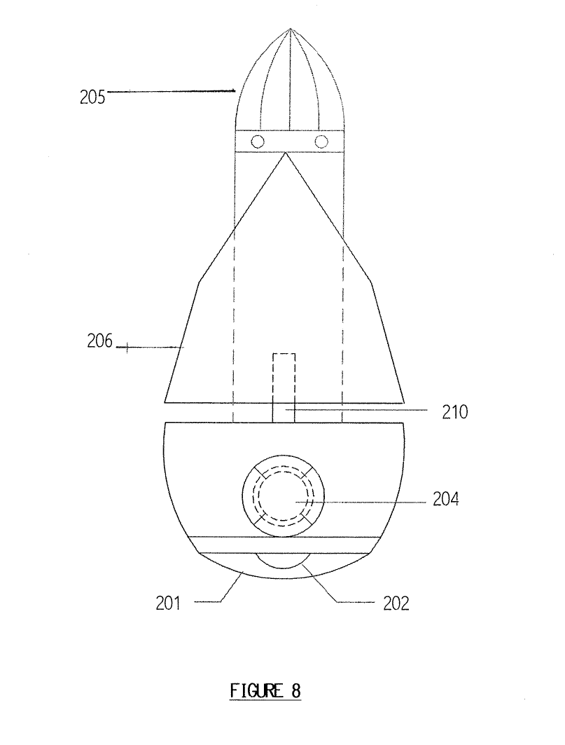

FIG. 8 is a rear view of the lighting apparatus in the second embodiment of the present invention;

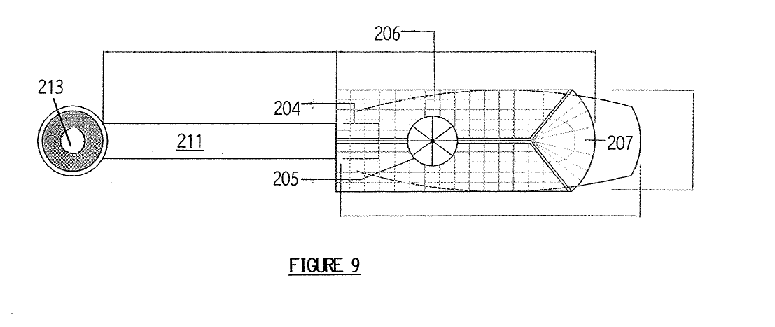

FIG. 9 is a plan view from above the lighting apparatus of FIGS. 6 to 9;

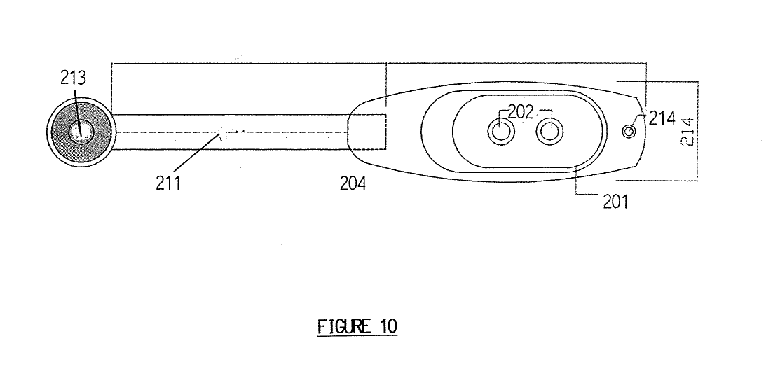

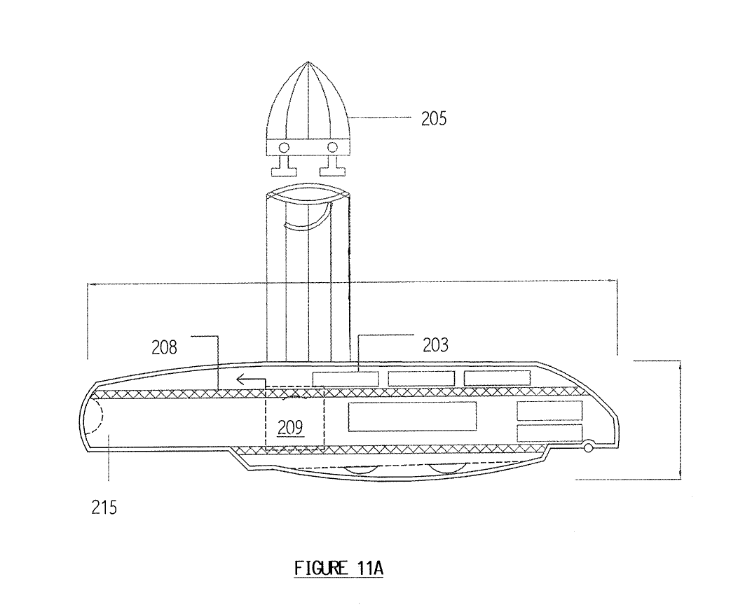

FIG. 10 is a plan view from underneath the lighting apparatus of FIGS. 6 to 10;

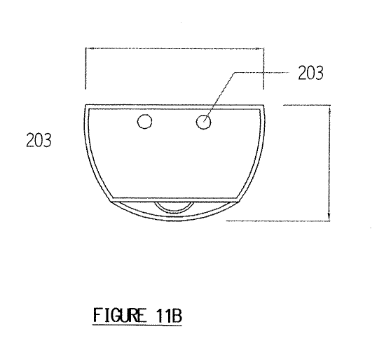

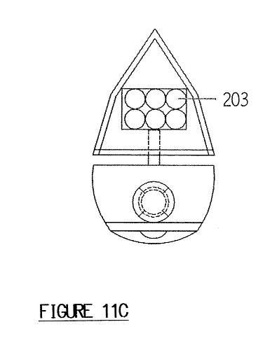

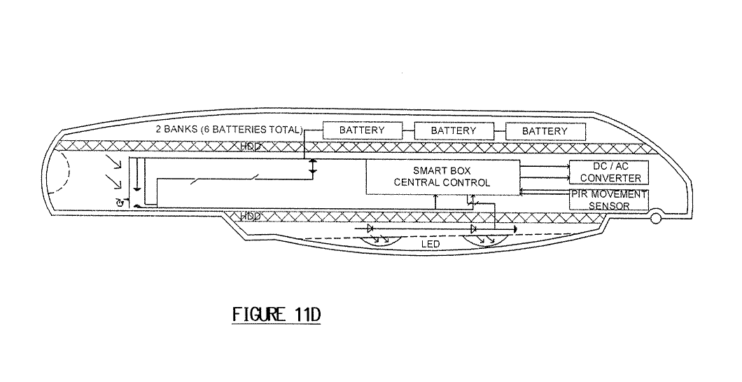

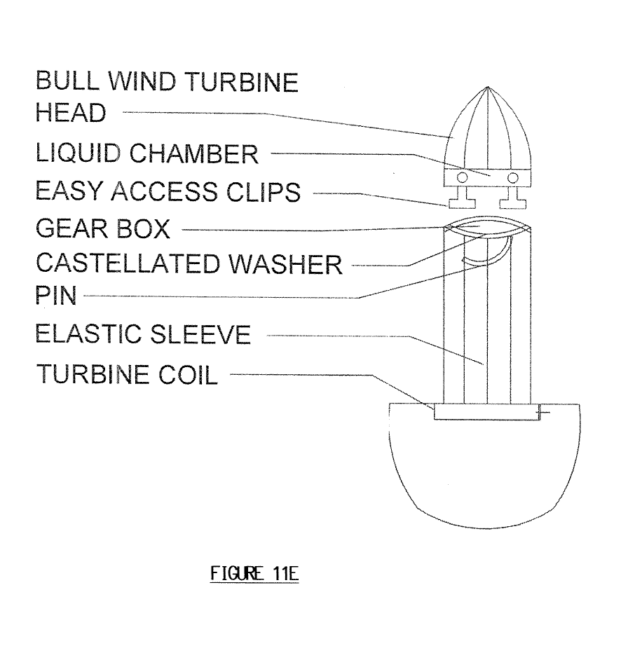

FIG. 11a is a longitudinal sectional view along the line A-A;

FIG. 11b is a transverse sectional view long the line B-B;

FIG. 11c is an internal view of the solar array;

FIG. 11d is an internal view of the light head;

FIG. 11e is a detailed view of the wind turbine;

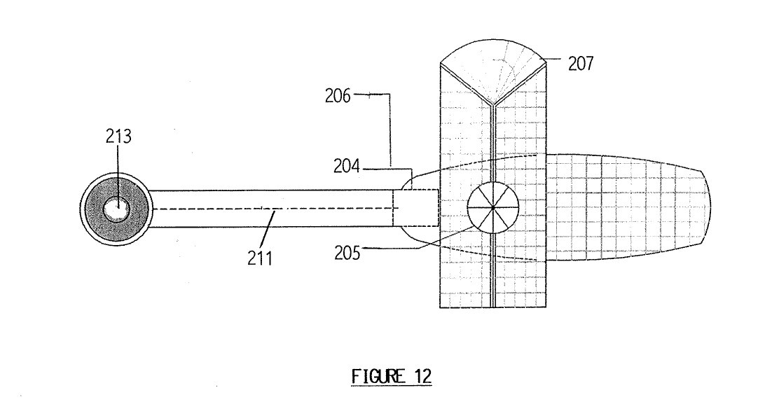

FIG. 12 is a plan view of the second embodiment turned through 90°; and

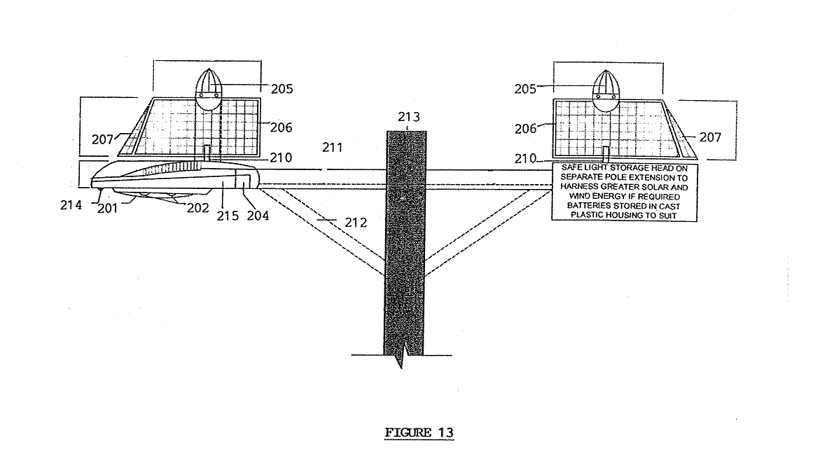

FIG. 13 is a side view showing a modification of the second embodiment with extra storage and support for a battery pack.

The following reference numerals will be used to refer to the following component parts of the present invention:

Component parts are indicated by the following reference numerals in drawings FIGS. 1 to 5 inclusive:
1. Opposite thread adapter
2. PIR 100 m Hazard directional sensor
3. Heat sump
4. Heat dispersal device (HDD) comprising a heat dispersal sheet
4a. Heat dispersal device (HDD) comprising a heat dispersal sheet
5. Circuit board and components
6. Lithium ion and gel batteries
7. Housing for the light source LED array, batteries and electrics and heat sump
8. LED array (2-100 LED unit array)
9 & 9a. Charcoal layer on the heat dispersal sheets 4, 4a, respectively
10. Cooling fan
11. Solar directional joint
12. Monocrystalline solar panel array
13. De-icing strip
14. Wind turbine (300 W vertical axis wind turbine)
15. Cooling air flow tunnel for cooling the solar panels
16. Easy access service hinge
17. Airflow vents in the light source housing
50. Support pole
100. Lighting apparatus of the present invention, generally indicated by 100

Referring initially to FIGS. 1 to 5 of the drawings, the lighting apparatus of the present invention is indicated generally by the reference numeral 100. The lighting apparatus 100 comprises at least one solar panel 12, but preferably at least two solar panels 12. The solar panels are preferably 30 W to 100 W monocrystalline solar panels.

Depending on the height of the pole or column on which the lighting apparatus 100 is to be mounted/installed (the pole/column height can vary from 6 m to 30 m multi-head); and depending on the area of illumination required on the ground i.e. the area over which light is required to be provided, the lighting apparatus can be increased or decreased in size, including increasing or decreasing the amount and strength of all the components of the lighting apparatus 100.

The lighting apparatus 100 also includes an array 8 of light emitting divides (LEDs) which are supplied with power from each of the solar panels 12 when sunlight is available to power the LED's. As an alternative energy source for powering the LED's 8, the lighting apparatus also comprises a wind turbine 14. The wind turbine 14 is also connected to provide energy to the LED array. However, as a back-up power source, the lighting apparatus 100 also includes at least one but preferably six 12 amp lithium ion batteries 6 and the array 8 of LED's may comprise of between 10 and 100 LEDs. In an alternative embodiment, the LED array 8′ comprises two 100 W LEDs and may also include a magnification globe to intensify the light emitted by the LED's (magnification globe not shown in the drawings).

The lighting apparatus 100 also comprises a sensor 2 which is preferably, a PIR sensor which detects motion within a distance of 100 m. The PIR sensor 2 is connected to the LED array and the sensor 2 configured such that when motion is detected by the sensor, such as from a moving pedestrian or vehicle, for instance, the sensor 2 triggers the LED array to turn “ON” to provide lighting. As the moving pedestrian or vehicle then passes under the lighting apparatus 100 and progresses further away again, the sensor 2 detects the movement and the LED array progressively dims until the LED's are turned “OFF”.

The roadway and street lighting apparatus 100 includes a coupling 1 adapted for connecting the apparatus 100 to an existing support structure such as a support pole 50. The coupling 1 adapted for connecting the lighting apparatus 100 to an existing support structure 50 preferably, comprises an opposite threaded coupling. However, as indicated above, the coupling 1 may alternatively, comprise any one of the following: opposite threaded joint, a bore hole with screw locks, a threaded collar or such like coupling which allows the lighting apparatus to be directly mounted to an existing lighting support structure.

Also included in the apparatus 100 is an easy access service hinge 16 to enable any maintenance work to be carried out though it is envisaged that the design of the lighting apparatus 100 ensures that minimal maintenance is required.

The solar panels 12 are mounted on a rotatable joint 11 (i.e. solar panel directional joint 11). This joint allows the solar panels to be rotated to the optimum location so as to be exposed to maximum exposure to the sun light. In use, the installing operator will be instructed as to how to arrange and orient the solar panels 12 to have maximum exposure in any given location for maximum sunlight to fall on the solar panels 12. The installing operator will then set and lock the relative location and orientation of each of the solar panels 12 based on this optimum setting for any given location. The solar panels 12 can be located at a 45 degree angle relative to each other. This angle is desired to prevent snow from settling on the solar panels 12. The installing operator uses a locking pin or screw (not shown) to lock the solar panels 12 in the optimum position and orientation relative to the sun's path at any given particular location. The area now free of cover from the movement of the solar array is also covered in solar panels.

The lighting apparatus of the present invention also comprises means for dispersing heat away from the light source. The means for dispersing heat comprise a first heat dispersing device (sheet) 4 which extends along the length of the array of LED's 8 and preferably also extends over the heat sump 3 so that the heat dispersal sheet 4 protects the electrical components 5 from heat created by the lighting source (LED array). A second heat dispersal sheet 4a is also included; the second heat dispersal sheet 4a being located above the LED array and is made up of a gel surround encasing the battery units. The heat dispersal devices (sheets) 4, 4a include a charcoal layer 9, 9a, respectively. Hot air gathered in the heat sump rises through the charcoal and is released through the wind tunnel 15. Water taken in from condensation is drained down and through the heat dispersing devices 4, 4a (HDD) and hence provides a natural air conditioning system within the lighting apparatus 100. Thus, the heat dispersing sheet 4 transfers heat from the region of the light source (i.e. the LED array) to the heat collecting sump 3 and then to the outside atmosphere so as to prevent overheating of the lighting apparatus. The means for dispersing heat also comprises a venting system including vents 17 in the light source housing 7. The vents 17 are designed to allow air to enter the housing 7 but to prevent water from entering; thus the vents 17 allow cool air to enter.

The lighting apparatus 100 also includes an opposite directional fan at the end of the wind turbine tunnel 15 at the top of the lighting apparatus 100, and ensures that there are air current flows of warm air being taken away as heat rises with cold air being fed down so as to provide a natural air conditioner together with the charcoal layers 9, 9a of the heat dispersal devices 4, 4a respectively. The cool air which can enter through vents 17 mixes with the heated air rising from the heat sump 3 and the warm air flow moves upwardly in the air flow pathway shown in FIG. 4 whereby the warm air is directed to the air tunnel 15 and flows upwardly towards the direction of the solar panels 12. The lighting apparatus 100 also includes venting apertures (not shown in the drawings) in the region of the solar panels 12 through which venting apertures, the warm air can exit to the atmosphere. The warm air may also be directed towards the wind turbine 14, through the wind tunnel 15 and directed to the rear of the solar panels 12.

The lighting apparatus 100 includes three Lithium ion batteries 6.50% of the power from these batteries is actually used so that there is 50% spare battery capacity. There is a 36 hours of back-up power available from the batteries. Layered above the batteries 6 is the heat dispersal sheet 4a with charcoal layer 9a. The air/wind tunnel 15 runs the length of the lighting apparatus 100. Up through the middle, there is a turn table/rotatable joint 11 on which the solar panels 12 are mounted so that the solar panels 12 can be turned in the optimum direction depending on the path of the sun so that the panels 12 face optimum sun light when fitted and the solar panels are then locked in this orientation using a locking pin. On top of turn table, up through a 25 mm hole where the solar panels 12 abut each other, the bull wind turbine 14 sits at the highest point. In use, as the wind turbine spins under the action of the wind, the turbine turns a fan 10 to generate air flow which directs the warm air upwardly through the air/wind tunnel 15.

The wind turbine 14 is preferably a 300 W vertical axis wind turbine. The vertical axis turbine 14 includes a rotational bull's eye socket coupling. The bull turbine 14 is not prone to vandalism because of its location and size. The wind turbine 14 sits on a ball and socket returning joint to withstand acts of nature, vandalism and provide extra power output.

The lighting apparatus 100 also includes a de-icing strip 13 for de-icing the solar panels 12 in the event of very cold or freezing weather. The de-icing strip 13 includes de-icing material such as salt and is adapted to release the de-icing material in freezing conditions so as to encourage thawing of any ice that may tend to form on the solar panels 12. This ensures that the solar panels 12 are available for converting solar energy to electrical energy to power the LED array for the maximum possible range of weather conditions. Directing warm air from the LED array and heat sump 3 to the solar panels 12 using the wind tunnel 15 ensures that the solar panels are kept operational in even extremely cold conditions. Directing the warm air to the solar panels to enable heat transfer at the solar panels is a key feature of the low maintenance lighting apparatus of the present invention. Using this warm air and directing it through the wind tunnel 15 to the solar panels 12 so that the solar panels are maintained at a temperature above the freezing point of water (i.e. above 0° C.) and preferably, maintained at above 2° C. so as to keep the solar panels 12 free of frost, ice and/or snow.

The lighting apparatus of the present invention has two on-off controls. The solar panels are used as a day night switch with a 100 m directional sensor below the light, which in turns triggers the adjacently located lighting apparatus 100.

If the sensor detects a potential hazard which has remained stationary under a lighting apparatus 100, the light will remain on, thereby providing an early warning system for alerting other road/street users of the hazard. This is important in urban areas but especially so in rural accident blackspots and to offer security in rural areas.

Referring now to FIGS. 6 to 13, a second embodiment of the lighting apparatus of the present invention will be described. The second embodiment of the lighting apparatus is indicated generally by reference numeral 200. The components of the lighting apparatus 200 are as follows:
200 Lighting apparatus of the second embodiment
201 Hinged protective lens
202 Magnification globe LED
203 6×12 amp power lithium ion gel surround battery pack
204 Universal pole adapter
205 Bull wind turbine
206 Photovoltaic (PV) solar panels (perforated)
207 Angled photovoltaic (PV) solar panels
208 Heat sump-heat dispersion device
209 Back to grid meter and associated electronics
210 Solar tracking joint (rotating)
211 75 mm pole extension and bolted bracket
212 Cantilever support arm (if required)
213 Existing pole upright
214 PIR detector
215 Power production connection

Referring now to FIGS. 6-13 the lighting apparatus 200 comprises the elements identified in the above table. The lighting apparatus 200 in the second embodiment operates in the same manner as described above in relation to the first embodiment.

The lighting apparatus 200 may comprise monocrystalline solar cells instead of photovoltaic solar cells referred to above in lighting apparatus 100.

Alternatively, the lighting apparatus 200 may comprise nano particle quantum dots solar cells.

The lighting apparatus of the present invention provides a lighting apparatus in the form of a unit which can easily be substituted for existing lamps on existing poles/support columns and which can save lives by providing adequate lighting when it is needed for all traffic including pedestrian and vehicular traffic.

It is to be understood that aspects of the present invention have been described by way of example only and it should be appreciated that additions and/or modifications may be made thereto without departing from the scope thereof as defined in the appended claims.

1. A lighting apparatus for roadway and street lighting comprising a sensor to detect movement, and a light source for emitting light, a solar panel for providing energy to the light source, wherein the lighting apparatus comprises means for dispersing heat away from the light source, all provided in one apparatus whereby the lighting apparatus is a stand-alone, self-sufficient unit which can be operated without a mains electricity supply.

2. A lighting apparatus as claimed in claim 1 in which the lighting apparatus comprises at least two solar panels which are provided abutting each other at a predetermined angle.

3. A lighting apparatus as claimed in claim 2 wherein the at least two solar panels are arranged over the light source.

4. A lighting apparatus as claimed in claim 1 wherein all components including operating parts, power supply and storage, LED head, operating systems heat sumps and deflectors of the lighting apparatus are inside a sealed system;
whereby the lighting apparatus provides smart lighting control levels including a solar panel sensing day/night switch and a PIR sensor to ensure that lighting is provided as and when needed for pedestrian and vehicular traffic, thereby having a significant advantage of ensuring sufficient lighting for protection of all roadway users;
wherein the light source comprises an array of Light Emitting Diodes (LED's).

5. A lighting apparatus as claimed in claim 1 wherein the means for dispersing heat away from the light source comprises means for directing the heat towards or to the solar panel.

6. A lighting apparatus as claimed in claim 5 wherein the means for dispersing heat away from the light source comprises a heat dispersing device (HDD) which transfers heat from a region of the light source to a heat sump and then to an outside atmosphere so as to prevent overheating of the lighting apparatus even when the lighting apparatus is operated in warm or hot climates.

7. A lighting apparatus as claimed in claim 6 wherein the means for dispersing heat away from the light source includes a tunnel leading from the region of the light source to a region of the solar panel wherein the means for directing heat towards or to the solar panel comprises an air flow tunnel for carrying warm air from at least one of the light source or the heat sump toward or to the solar panel whereby directing the warm air from an LED array and the heat sump to the solar panel using a wind tunnel ensures that the solar panel is kept operational in even extremely cold conditions whereby the warm air directed to the solar panel to enable heat transfer at the solar panel enables the solar panel to be maintained at a temperature above 4° C.;
optionally wherein the heat dispersing device (HDD) includes charcoal thereby providing a charcoal air conditioning device (CACD).

8. A lighting apparatus as claimed in claim 7 wherein the means for dispersing heat away from the light source also comprises a venting system including vents in a light source housing which allow cool air to enter and also includes venting apertures in the region of the solar panel through which apertures, the warm air can exit, whereby in cool climates where the temperature drops to minus degrees, the air flow tunnel of the lighting apparatus carries the warm air to the solar panel which prevents ice or snow from covering the solar panel and delaying or preventing solar panel energy output; and
optionally wherein the means for dispersing heat away from the light source also comprises the wind tunnel through which the warm air may flow so as to exit through the venting apertures.

9. A lighting apparatus as claimed in claim 1 wherein the lighting apparatus also includes a wind turbine to provide a back up source of energy supply to the light source;
optionally wherein the wind turbine is mounted above the solar panel.

10. A lighting apparatus as claimed in claim 9 wherein the lighting apparatus utilizes solar energy from photovoltaic cells and the wind turbine which optionally comprises a vertically orientated curved bull wind turbine for power generation and supply of power to the light source;
optionally wherein the bull wind turbine is positioned on a ball and socket returning joint to withstand acts of nature, vandalism and create extra energy output which is available to an LED array or for harnessing to a mains electricity supply grid.

11. A lighting apparatus as claimed in claim 1 wherein the lighting apparatus includes a coupling adapted for connecting the lighting apparatus to an existing support structure such as a support pole whereby the lighting apparatus can be mounted on any support, including a timber frame, for instance, since the lighting apparatus does not require any electricity feed from a mains electricity grid whereby it is not necessary for all the elements of the apparatus to be replaced in their entirety including replacement of the support structure when replacing existing street/roadway lighting with the lighting apparatus as claimed in claim 1;
optionally wherein the coupling adapted for connecting the lighting apparatus to an existing support structure is selected from one of the following group: an opposite threaded joint, a bore hole with screw locks, a threaded collar or such like coupling which allows the lighting apparatus to be directly mounted to an existing lighting support structure.

12. A lighting apparatus as claimed in claim 1 wherein the lighting apparatus comprises a Heat Deflector Device above a protective glass and magnification globe, at least one LED, a heat sump, a power source which may comprise Lithium ion batteries, solar panels set at a 45 degree angle and a wind tunnel extending substantially the length of the lighting apparatus; a turn table on which the solar panels sit and can be turned to face optimum sunlight when fitted and locked with locking means, a wind turbine being located over the solar panels whereby, in use, as the wind turbine spins under action of wind, the wind turbine turns a fan provided in the lighting apparatus.

13. A lighting apparatus as claimed in claim 1 wherein the lighting apparatus comprises at least one on-off control means, optionally the solar panel being capable of being used as a day/night switch with a second sensor located below the light source, which in turns triggers the adjacently located lighting apparatus.

14. A lighting apparatus as claimed in claim 8 wherein the Heat Dispersal Device which may comprise a compact sponge stones fed with rain water where applicable and condensation in warm climate with a wind fan feeding the heat sump; the lighting apparatus uses the same heat dispersing device (HDD), wind tunnel and Charcoal Air Conditioning device (CACD) in all climates and settings;
wherein the CACD is supplied, in hot climates, using condensation and the heat and the warm air which is distributed using fans and the wind tunnel which directs the warm air from the LED array to the solar panel where the warm air can be used to heat the solar panel so as to thaw any frost, ice or snow that may have lodged on the solar panel during extreme weather conditions, the warm air is then vented to the atmosphere through the venting apertures in the solar panel, in minus degrees temperatures the heat sump will be cooled by directing the warm air through the wind tunnel and released over a face of the solar panel to prevent freezing over of the solar panel.

15. A lighting apparatus as claimed in claim 1 wherein a lighting apparatus control panel is situated in a tip of the light source away from a heat source and with no expensive unreliable digital devices.

16. A lighting apparatus as claimed in claim 12 wherein power may be generated by at least one of the solar panels or the wind turbine in excess of the power that is needed to operate the LED; preferably, the lighting apparatus includes means for transferring any such excess power generated by at least one of the solar panels or the wind turbine not needed to operate the LED to a main electricity grid, and thus, the lighting apparatus has electricity grid return capabilities using pre-existing electricity supply feeds.

17. A lighting apparatus as claimed in claim 12 wherein the lighting apparatus comprises a power point for connection to electric vehicles (EVs) such as electric cars whereby batteries of the electric vehicles can be re-charged using power generated by the solar panels and the wind turbine included in the lighting apparatus whereby the electric vehicles (EVs) including electric cars can be charged using a fast charge supplied using groups of approximately 100 of the lighting apparatuses with the electrical power being supplied from the lighting apparatuses to a storage point such as a holding tank, using a main grid return supply thereby creating or providing a garage forecourt for the electric vehicles (EVs).

18. A lighting apparatus as claimed in claim 1 wherein the lighting apparatus comprises a vandal guard which for instance, can be incorporated into a lighting housing.

19. A lighting apparatus as claimed in claim 1 wherein the lighting apparatus comprises means for monitoring speed of vehicles;
optionally wherein the means for monitoring speed vehicles comprises at least one of a camera or a PIR sensor to determine a time period that elapses between a vehicle passing a first lighting apparatus and a next lighting apparatus.

20. (canceled)
